(19) United States
(12) Patent Application Publication
(10) Pub. No.: US 2011/0067246 A1
(43) Pub. Date: Mar. 24, 2011

(54) Linear slide action mechanical folding knife opening mechanism

(76) Inventor: Michael Gregory Perez, Miami Springs, FL (US)

(21) Appl. No.: 12/803,660

(22) Filed: Jul. 1, 2010

Related U.S. Application Data
(60) Provisional application No. 61/222,608, filed on Jul. 2, 2009.
(60) Provisional application No. 61/245,129, filed on Sep. 23, 2009.
(60) Provisional application No. 61/259,370, filed on Nov. 9, 2009.
(60) Provisional application No. 61/351,278, filed on Jun. 3, 2010.

(51) Int. Cl. B26B 1/02

(52) U.S. Cl. 30/158

(57) ABSTRACT

One embodiment of folding knife using a mechanical linear slide action blade deployment system housed in a predetermined shaped cavity (28). Said slide action blade deployment system is comprised of a sliding member (1) made of a heat treated steel alloy and coated for low friction and high wear. Sliding member (1) is actuated by short linear thumb pressure on a sloped tab (5) located on top handle (2), thus transmitting sliding force from sliding member leading edge to blade opening pin (13) made of heat treated and coated for low friction and high wear attached to blade (3) axle at a predetermined location. This action causes blade top rotate out of handle to the locked open position. Thumb actuated sloped tab on top handle returns to starting position via a sloped tab return spring (16) housed in a cavity between inside top handle and top liner (11).

This application claims the benefit of PPA application No. 61/222,608, filed, Jul. 2, 2009; 61/245,129, filed Sep. 23, 2009; 61/259,370, filed, Nov. 9, 2009; 31/263,252, filed, Nov. 20, 2009; 61/351,278, filed, Jun. 3, 2010.

This application relates in particular to a folding knife equipped with a mechanical device, mechanism, for deploying or opening the blade.

### BACKGROUND OF THE INVENTION

The traditional folding knife, sometimes also known as a pocket knife, has one or more blades pivot ably mounted within a housing or casement. To prevent accidental opening of the knife, each blade typically is biased in the closed position by a mechanism such as a spring or detent. To open the blade, the user must insert the thumbnail of one hand into a notch or groove provided for that purpose near the back edge of the blade, and manually rotate the blade around its pivot point at one end of the knife body while holding the body with the other hand. This opening technique can be difficult to accomplish, particularly for those having short thumbnails or for a handicapped person who may not have full use of both hands, or with knives whose blade pivot mechanism is relatively stiff. Women, who customarily have longer fingernails than men, are hesitant to use a pocket knife because they are apt to damage or break the thumbnail used to open the blade. Moreover, it is essential in some jobs, such as commercial fisherman, paramedics, police, military, to open and use a knife with one hand while the other hand is otherwise occupied.

Folding knives with various mechanisms for opening or assisting with opening the blade are known in the art. For example, U.S. Pat. No. 249,896 discloses a knife equipped with a handle for unloading the spring force that normally keeps the blade closed. The blade also has the conventional thumbnail notch; the user, after first manipulating the handle to remove spring force from the blade, must then open the blade using the thumbnail notch as usual. This arrangement appears relatively awkward to implement, because the user must grasp the knife in one hand while manipulating the handle with the other hand, and then use the thumb and forefinger of that other hand to pivot the blade outwardly from the handle.

The so-called switchblade knife, where the closed blade is under spring tension and opens at the touch of a button, is illegal in many jurisdictions. Furthermore, the side-opening switchblade requires a safety device, usually a sliding button, so that the knife will not open accidentally in one's pocket. This safety must be manually moved to the off position prior to opening the knife, so that one must initially position the knife in one hand to operate the safety and then reposition the knife to press the button which releases the spring-tensioned blade. This is a time-consuming and awkward movement. U.S. Pat. No. 22,620 discloses a folding knife with a handle directly connected to the pin which pivot ably mounts the blade in the handle. U.S. Pat. No. 2,416,277 shows a pocket knife having a rack-and-pinion arrangement for opening or closing the blade when a sliding bar is moved longitudinally along the blade housing. These arrangements, in common with the first-mentioned prior patent, have various practical disadvantages, among which is the need for using two hands when opening the blade. U.S. Pat. No. 4,719,700 by the present inventor discloses a folding knife designed for opening a blade by moving an actuator button longitudinally along the blade housing. This arrangement represents a step forward in the art, as it allows the user to open the knife with only one hand. However, the operating mechanisms employed with the knife disclosed in that patent required a considerable amount of straight-line force applied to the sliding actuator, particularly when overcoming the inertia of the blade at rest. Furthermore, a knife using the rack and pinion drive disclosed in that patent would be much thicker than the conventional pocket knife and would be less appealing in appearance. U.S. Pat. No. 6,360,443 discloses a folding blade knife which may comprise a handle member, and including at least one upper handle member and at least one lower handle member defining a channel. The knife may further include a blade member pivotally mounted, via a pivotal member, to the handle member and within the channel. This invention has a complicated arrangement of rods and pivot connection points.

U.S. Pat. No. 5,495,674 discloses a tri-fold knife is provided which has a blade having a tang and bifurcated handle. The handle has a main handle which has a forward end which is pivotably attached to the tang. The main handle terminates in a butt end. A tail handle is provided with a forward engaging end and a butt end coupling. Blade pivots in and out as knife is opened. The blade as it is opening does not inspire confidence because of the extra movement of blade not to mention the complicated mechanism arrangement. U.S. Pat. No. 3,158,127 discloses a knife having a casing and a blade pivotally mounted thereto includes a user actuated button slidably mounted to the casing for producing movement of the blade between fully open and closed terminal positions. The slide button is located too close to blade axis center, making it difficult to provide torque (lift) needed start blade opening sequence. Marketed version of this knife was never very commercially successful. There are a number of mechanical folding knife opening mechanism, however, none of them open the blade with ease of operation and single moving part design. The present application contemplated does exactly that. This application offers a improved new way to open a folding knife using only mechanical leverage. It essentially relocates the traditional thumb opening tab/pin to a new location closer to blade axle, and pushes it to open blade with a sliding member traveling in a cavity cut out in top handle material The sliding member has a leading edge with a predetermined shape designed for torque and speed. The sliding member's linear movement cause the leading edge to make contact with blade opening tab/pin, thus opening knife blade.

### REFERENCE LIST OF PARTS

(1) Sliding member
(2) Top handle
(3) Blade
(4) Pivot pin
(5) Sloped tab
(6) Sliding member to sloped tab fastener
(7) Clearance cavity for blade opening pin
(8) Sliding member working angle
(9) Sliding member to sloped tab fastener hole
(10) Sliding member spring return cavity
(11) Top liner
(12) Clearance channel for blade opening pin
(13) Blade opening pin
(14) Liner spring return cavity
(15) Pivot pin hole
(16) sliding member and sloped tab return spring
(17) Handle slot
(18) Member leading edge
(19) Inside top handle
(20) Knife assembly fasteners
(21) Knife assembly holes
(22) Sliding member to sloped tab assembly reinforcement fasteners
(23) Sliding member to sloped tab assembly threaded liner holes
(24) Liner spacer couplings
(25) Bottom locking liner
(26) Bottom handle
(27) Blade open position stop
(28) Sliding member handle cavity
(29) Pivot pin nut
(33) Washers

### Alternate Embodiment Differences

(30) Small cavity
(31) Redesigned sliding member with side located thumb tab
(32) Redesigned slide member cavity
(34) Sliding member reinforcement fasteners
(35) Sliding member reinforcement threaded holes

### DESCRIPTION

### Fig. List:1-8

This embodiment of the linear slide action mechanical folding knife opening mechanism is illustrated in the above cited figure list.

This embodiment uses a sloped tab (5), connected to a sliding member (1), thru handle slot (17) using sliding member to sloped tab fastener (6) into sliding member fastener hole (9).

Sliding member (1) travels in a sliding member handle cavity (28). Sliding member handle cavity's (28), position, and sliding member working angle (8), maximize torque and speed when launching knife blade open. Liner spring return cavity (14) and member spring return cavity (10) house and hold captive sliding member and sloped tab return spring (16). A blade opening pin (13) is attached to blade (3) at a predetermined distance from pivot pin hole (15). A clearance channel for blade opening pin (12), and clearance cavity for blade opening pin (7), allow blade opening pin (13) and member leading edge (18) to be aligned on the same horizontal plane for proper knife opening. Sliding member to sloped tab reinforcement fasteners (22) and sliding member to sloped tab threaded liners holes (23), reinforce area adjacent to sliding member (1) by further attaching top handle (2) with top liner (11). Pivot pin (4) is mounted thru a plurality of pivot pin holes (15) in top handle (2), top liner (11), Thru two washers (33) on both sides of blade (3), bottom locking liner (25), bottom handle (26), and is held secure with a pivot pin nut (29). Knife assembly holes (21) in top of handle (2), and bottom handle (26), allow knife assembly fasteners (20), to fasten with liner spacers couplings (24) thru top liner (11) knife assembly holes (21). Inside top handle (19) houses knife opening mechanism specific components, while the bottom handle (26) does not. Over travel of blade (3) when opening knife is prevented by a blade open position stop (27).

### Operation:

This embodiment describes a Linear slide action mechanical folding knife opening mechanism that uses linear force or push on a sloped tab (5) fastened to sliding member (1) thru a handle slot (17) in top handle (2) material. When knife is assembled, pivot pin (4), pivot pin nut (29), as well as knife assembly fasteners (20) and knife assembly holes, provide the required alignment needed for proper operation of knife opening mechanism. The mechanical leverage to open blade (3) is accomplished by using a predetermined member leading edge shape (18) pushing against a blade opening pin (13) of a predetermined shape at a predetermined sliding member working angle (8). These three design elements provide the required torque and speed to launch the knife blade open. Blade is locked open with standard bottom locking liner (25), but could use some other knife locking mechanism. After knife blade is opened, sliding member (1) and sloped tab (5), return to their stating positions by way a sliding member and sloped tab return spring (16) held captive between the liner spring return cavity (14) and member spring return cavity (10). Space for knife opening mechanism movement of sliding member (1) and blade opening pin (13), is accomplished with a sliding member handle cavity (28), clearance cavity for blade opening pin (7), and clearance channel for blade opening pin (12).

The position of the mechanism under top handle (2), adds to the ergonomics by placing knife opening sloped tab (5) right where thumb is naturally positioned while holding knife. Knife action is snappy, fluid and repeatable. During knife blade opening sequence, member leading edge (18) maintains contact with blade opening pin (13) for approximately first 100 degrees of blade (3) rotation. For the end user this means easier actuation of knife opening controls.

This applications design uses a short linear throw or push of a sloped tab to more easily apply the force necessary to open a folding knife without the worry of missing a thumb opening tab or stud. The short linear travel direction of this design insures that the users digit will maintain contact with sloped tab. This design uses a single moving part and simple mechanical leverage to give the end user a superior alternative to difficult complicated mechanisms and not well thought out knife opening control placement mentioned in prior art. This application is not all inclusive, and other embodiments of this application are possible.

### Alternate Embodiment

### FIG. 9-15

There are several alternate embodiment possible of the linear slide action mechanical folding knife opening mechanism. One other embodiment uses a redesigned sliding member with side located thumb tab (31). Side located thumb tab is along side of top handle material (2), over blade (3) in approximately the same position as a standard thumb opening tab. A small cavity is located at end of redesigned side thumb tab's travel in top of handle (2) and top liner (11). Knife is opened in the traditional way by applying thumb push force to redesigned sliding member with side located thumb tab (31). While opening knife blade and at end of thumb tab travel, thumb tab parks in small cavity (30) using compression fit.

A redesigned sliding member cavity (32) provides clearance inside top handle (2) for said knife opening mechanism movement. By placing thumb tab in a more traditional position it allows the end user a more familiar opening operation, albeit, but with a easy, short controlled linear throw, instead of the momentary and not always successful “marble shooting thumb snap” of the traditional thumb tab.

This applications design uses a short linear throw or push of the thumb tab to more easily apply the force necessary to open a folding knife without the worry of missing the thumb opening tab or stud. The linear travel direction of this design insures that the users digit will maintain contact with thumb tab. This design uses a single moving part and simple mechanical leverage to give the end user a superior alternative to difficult complicated mechanisms and not well thought out knife opening control placement mentioned in prior art.

### BRIEF DESCRIPTION OF DRAWINGS

FIG. 1 is a left side view of slide action folding knife according to first embodiment of the invention. Shown is a predetermined type of knife fastening assembly. In addition, a predetermined number and type of sliding member reinforcement fasteners.

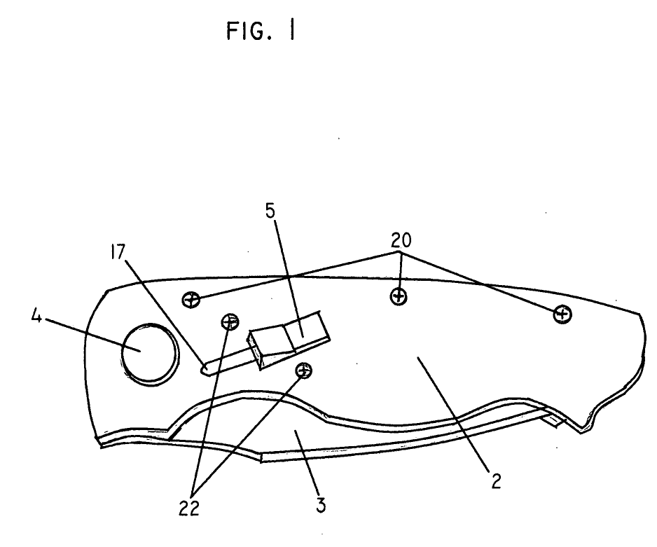

FIG. 2 is an enlarged left side cutaway of top liner and knife blade during actuation of linear slide action mechanical folding knife opening mechanism. According to first embodiment of the invention. Shown is sliding member, blade opening pin, clearance channel for blade opening pin and a predetermined number of sliding member reinforcement fastener threaded holes in liner.

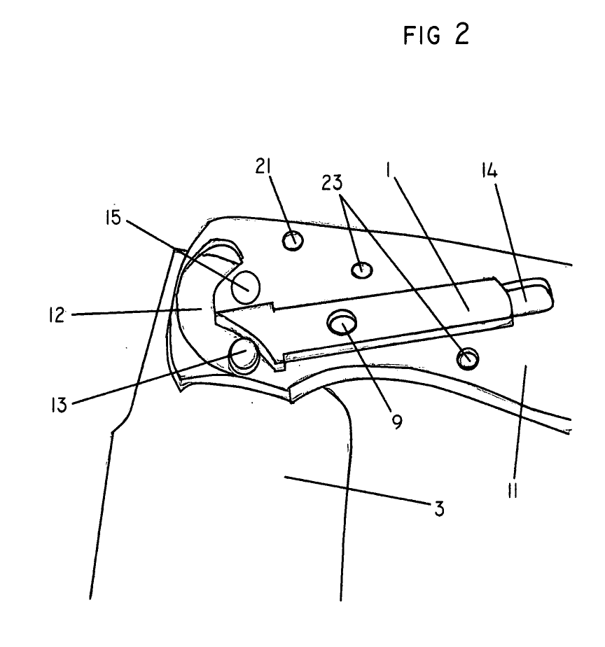

FIG. 3 is a left side cutaway view of folding knife during actuation of linear slide action mechanical folding knife opening mechanism. Shown is clearance channel for blade opening pin, right liner with sliding member pushing on blade opening pin. A predetermined number of knife fastener assembly holes.

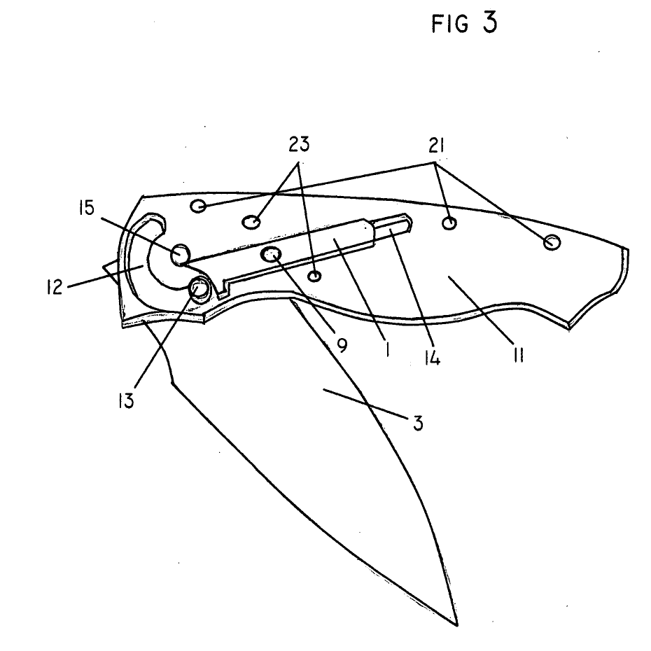

FIG. 4 is a view of inside left/top handle according to first embodiment of the invention. It shows predetermined mechanism routing/channel dimensions in handle material. It shows sliding member in sliding member cavity and sliding member return spring used to reposition sliding member back to starting position after each forward actuation.

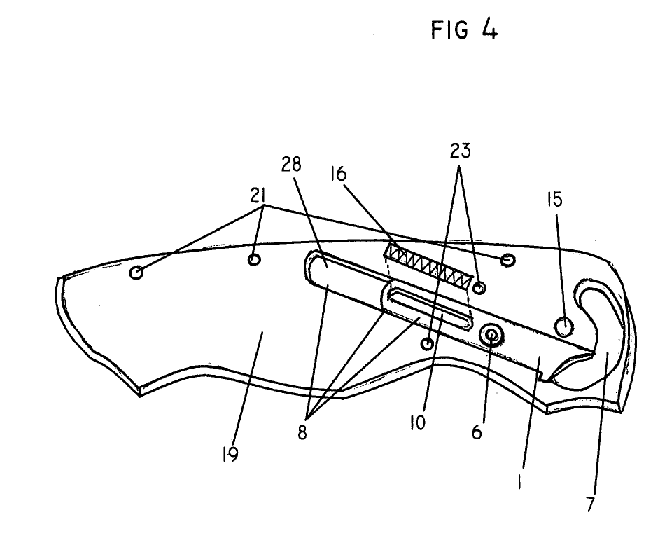

FIG. 5 is a view of right inside of top liner according to first embodiment of the invention. Top liner (FIG. 4), and mechanism specific parts are lined up with inside left top handle and housed between them. Additionally there are a predetermined number of knife assembly holes.

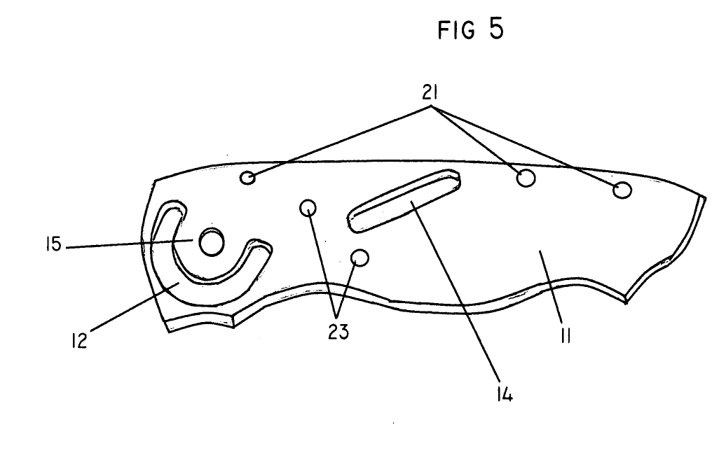

FIG. 6 is a top view of slide action folding knife with blade in open position according to the first embodiment of the invention. Shown are liner spacer couplings, Sloped tab.

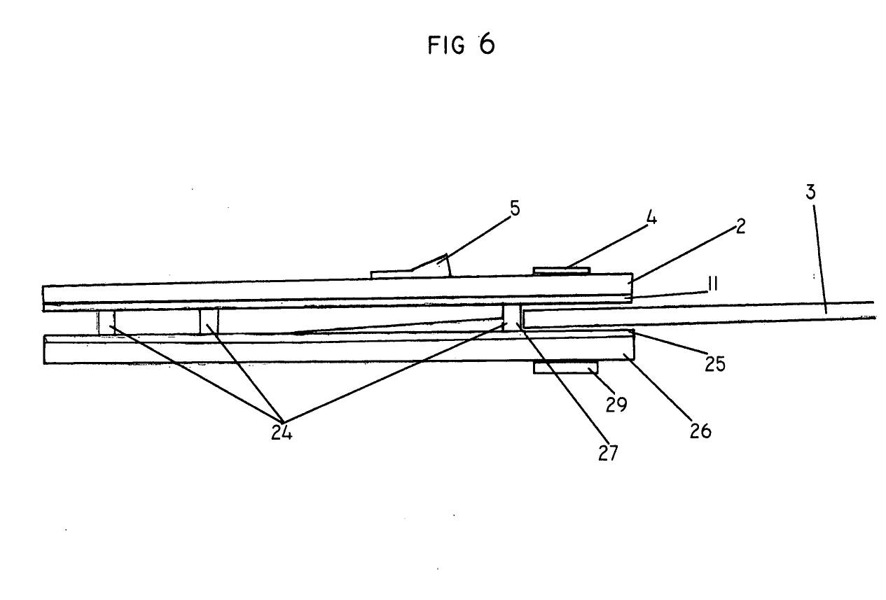

FIG. 7 is a view of bottom of slide action folding knife with blade in the open position according to the first embodiment of the invention. Shown are a predetermined number of liner spacer couplings, sloped tab, bottom locking liner.

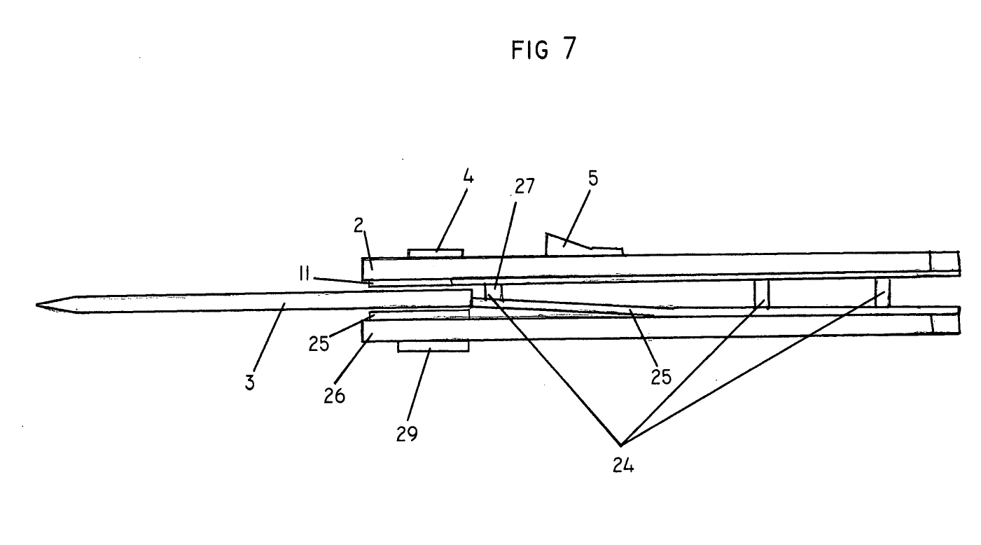

FIG. 8 is a right side view of slide action folding knife in the folded position according to the first embodiment of the invention.

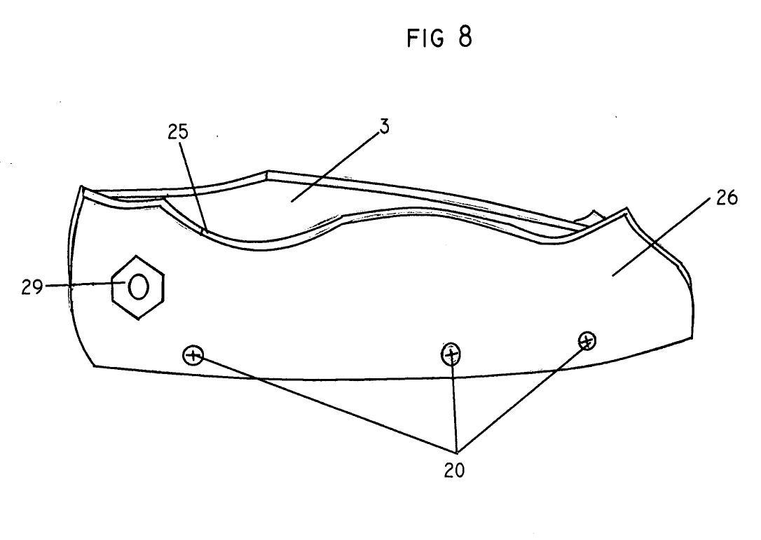

FIG. 9 is a left side view of alternate embodiment of the linear slide action mechanical folding knife mechanism. Shown is side located thumb blade opening tab/boss in the starting/knife folded position.

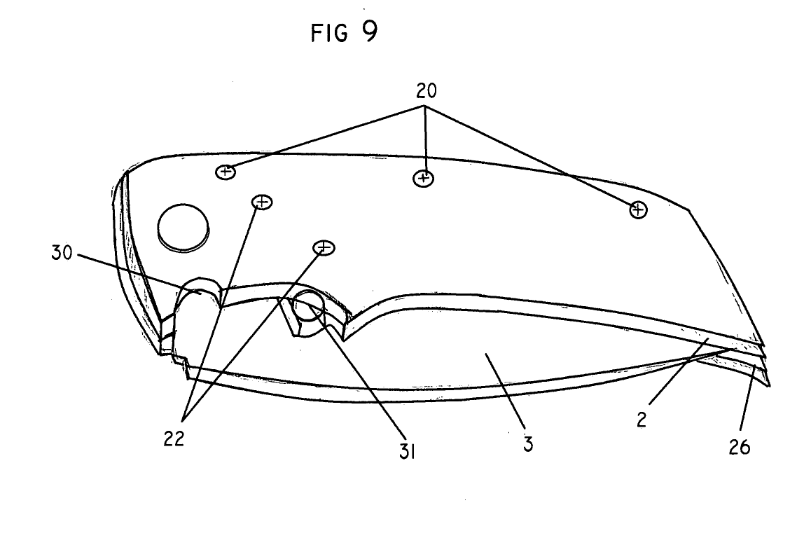

FIG. 10 is a left side view of alternate embodiment of linear slide action mechanical folding knife invention in the blade open position. Shown is side located thumb tab/boss in the forward, positioned in small cavity.

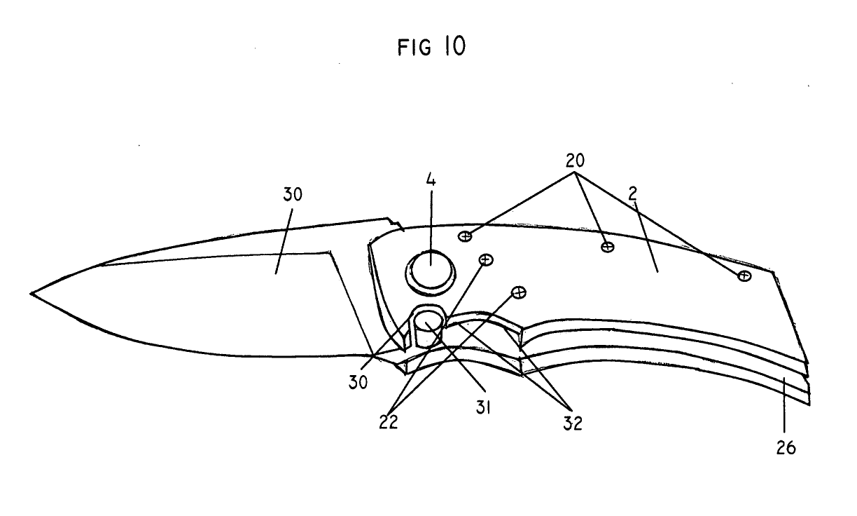

FIG. 11 is an exploded left side view of alternate embodiment of the linear slide action mechanical folding knife mechanism invention. Shown is predetermined sliding member shape with side located thumb tab/boss, top/bottom handle, pivot pin, pivot pin nut. Fastener holes.

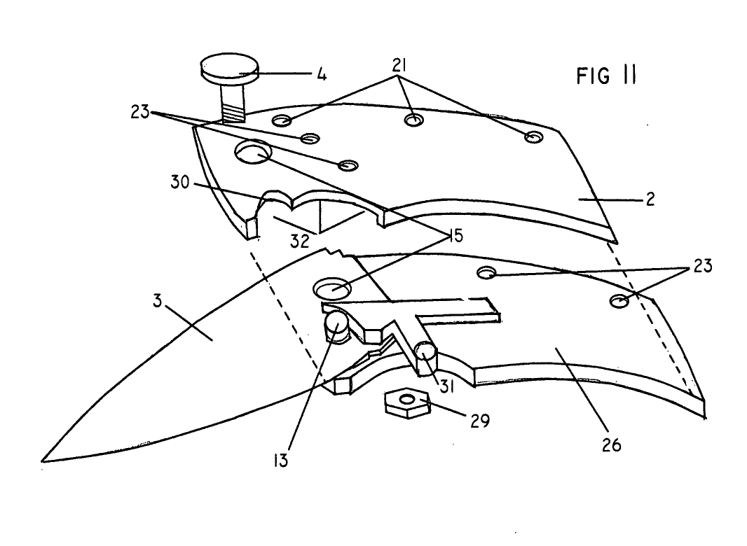

FIG. 12 is an inside left handle view of inside left handle sliding member cavity of a predetermined shape used to house and direct movement of sliding member with side located thumb tab/boss. According to alternate embodiment of the invention.

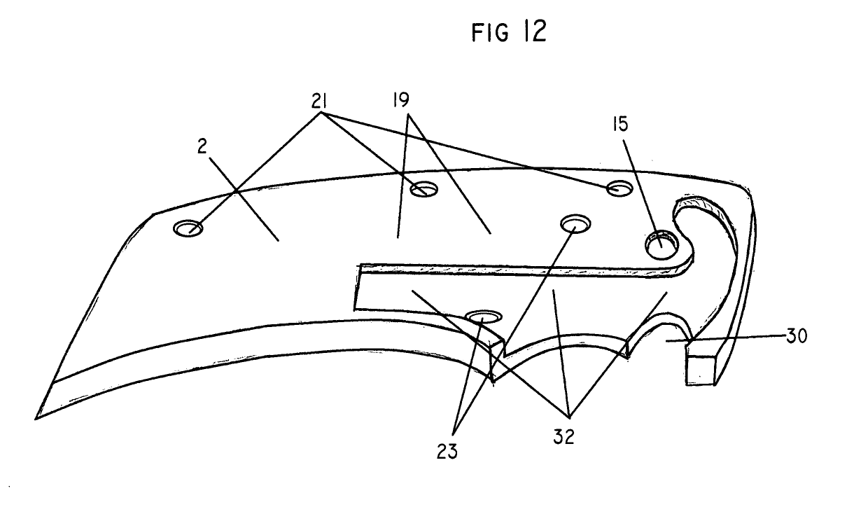

FIG. 13 is a view of a predetermined blade open locking mechanism (ie locking liner) aligned with right knife handle material. Also shown is a predetermined number and type of fasteners. According to alternate embodiment of the invention.

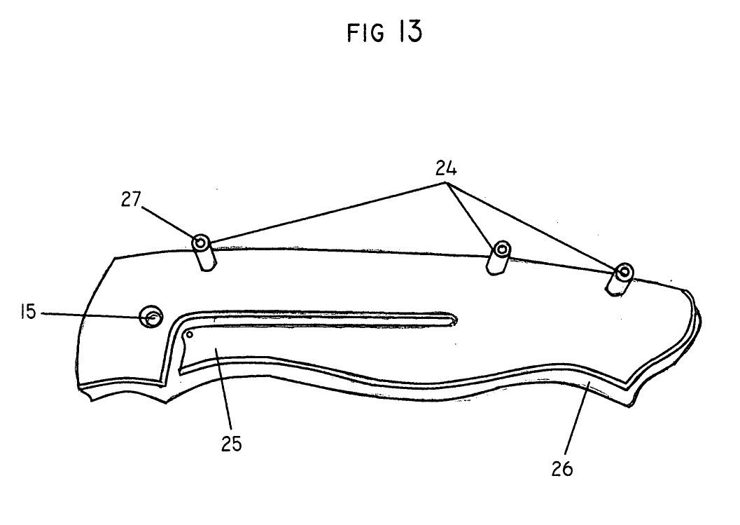

FIG. 14 is an exploded view of linear slide action folding knife according to the first embodiment. Reference parts list.

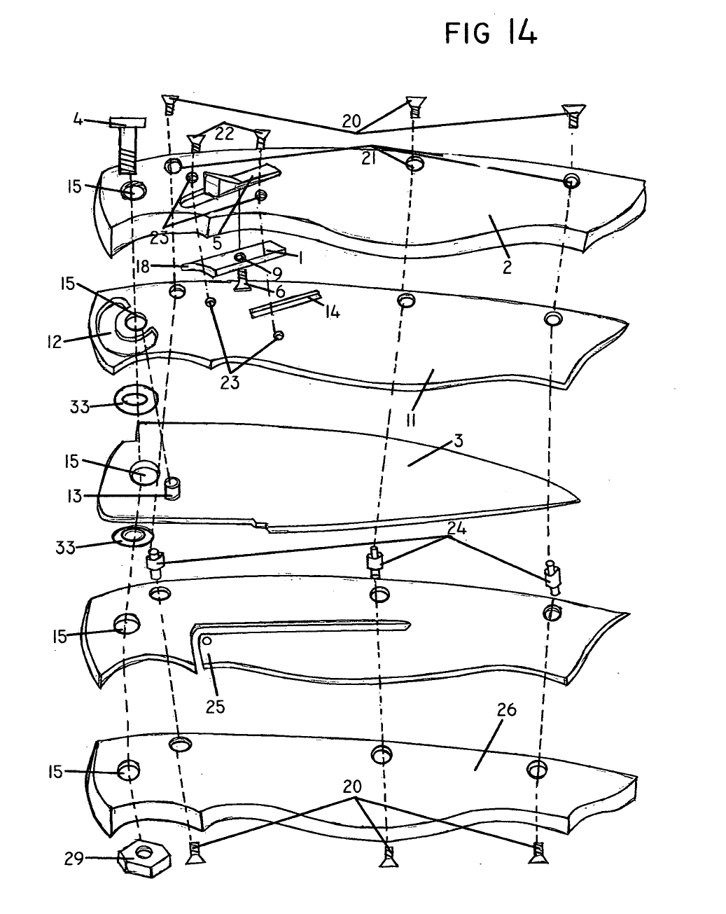

FIG. 15 is an exploded view of linear slide action folding knife according to the alternate embodiment. Reference parts list.

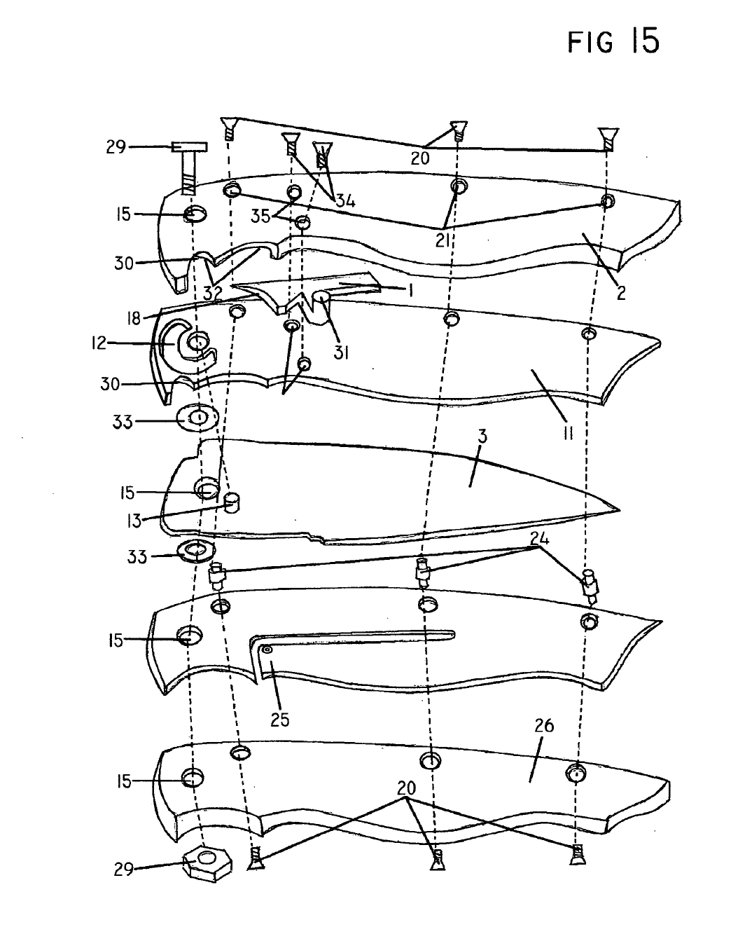

I claim:

1. A linear slide action mechanical folding knife opening mechanism comprising:

2. The method of claim 1 wherein said predetermined crossectional shape of said member is modified so as to reposition redesigned sloped tab at end of a boss protruding out from side of member at an angle so as to position said sloped tab for thumb actuation of said mechanism in a position along side of said top handle.

3. The method of claim 1 wherein said cavity in said top handle is modified to accommodate said redesigned sliding member for proper knife opening function.

4. The method of claim 1 wherein said top handle and said top liner have a cavity forward and along side in said top handle and said top liner. Said cavity is positioned at end of said knife opening mechanisms forward travel. Said cavity provides a compression fit, parked position in side of said top handle and said top liner for said thumb actuated tab at end of its travel.
Whereby a traditional thumb tab position for opening a folding knife is provided to end user, but with a superior controlled linear thumb push actuation
